(19) United States
(12) Patent Application Publication
(10) Pub. No.: US 2015/0310471 A1
(43) Pub. Date: Oct. 29, 2015

(54) Method and System for Social Gamification of Commercial Offers

(71) Applicants: Radoslav P. Kotorov, Somerset, NJ (US); Yoshiko Akai, New York, NJ (US); Toshifumi Kojima, Earnest Hills, NY (US)

(72) Inventors: Radoslav P. Kotorov, Somerset, NJ (US); Yoshiko Akai, New York, NJ (US); Toshifumi Kojima, Earnest Hills, NY (US)

(21) Appl. No.: 14/690,390

(22) Filed: Apr. 18, 2015

Related U.S. Application Data
(60) Provisional application No. 61/984,409, filed on Apr. 25, 2014.

(51) Int. Cl. G06Q 30/02

(52) U.S. Cl. CPC G06Q 30/0217; G06Q 30/0223; G06Q 30/0235

(57) ABSTRACT

A method and system for generating and processing socially gamified offers. It comprised a software application for specifying the offer parameters such as discount, expiration date, gamification type, posting the offers to a network, and monitoring the gamification outcomes to unlock the offer. It further comprises a server and a software application for redistributing the offers and managing the gamified interactions. It further comprises of a gamification engine that allows the offers to be activated based on different types of interactions by the network users. The gamification can require reaching a threshold of social endorsements for the offer to activate. Various types of gamification algorithms are used to create different types of engagements with the network participants.

### CROSS REFERENCE OF RELATED APPLICATIONS

This invention claims priority, under 35 U.S.C. §120, to the U.S. Provisional Patent Application No. 61/984,409 to Kotorov, Akai and Kojima filed on Apr. 25, 2014, which is incorporated by reference herein.

### FIELD OF THE DISCLOSURE

The present invention relates generally to the technical fields of gamification, unlockable gaming, and digital commercial offers processing, and, more particularly, to using social gamification rules and incentives to indirectly drive more and faster consumer purchases.

### BACKGROUND OF THE INVENTION

While shopping is an innate social experience, the current offer issue and processing systems fail to capitalize on the opportunity to drive more offer redemptions through computer-implemented socialization processes. Currently, all consumer offer incentives fall into two categories: (1) pure monetary incentives such as discount coupons found in circulars and magazines, and (2) monetary incentives combined with behavioral triggers such as a discounts or items available only within 10 minutes time interval. Offers containing pure monetary incentives have lost their appeal because consumers have learned to expect them, and, thus, they do not affect their purchasing behavior. Hence, retailers see them as a necessary evil that drives margins down without bringing more sales. The current behavioral based offers play on the negative anxieties of individual consumers by creating a perception of scarcity and a feeling of missing out on an opportunity. Neither scheme drives better consumer experience nor wider awareness of products and services.

Social gamification offers an opportunity to create behavioral offers that leverage the positive feelings associated with the engagement of friends and peers in the purchasing decision. By making the final value of the offer contingent on the level of social engagement, the present social gamification method and system provides incentives to consumers to share the offers with their peers via social and communications networks to solicit opinions and advice. On the one hand, social persuasion helps individuals make faster and more gratifying purchasing decisions. Consumer research shows that the majority of shoppers experience the “pain-of-deciding” when making purchasing decisions. Instead of deliberating on the pros and cons of the item of interest, consumers tend to abandon shopping carts and walk-out. Social persuasion, i.e., the endorsement of the purchasing decision by one's friends and peers, drives conversion rates among the vast majority of undecided consumers who like to look and try but do not buy. On the other hand, social gemification drives awareness and willingness to try and buy by leveraging the group dynamics of the individuals who interact with the socially gamified offers. Individuals who endorse an offer are more likely to try the item on offer themselves. Retailers benefit too as they can connect with the individuals who have endorsed particular items by curating personalized gamified offers for them. The present invention provides a method and a system to fulfill these needs.

The method and system for social gamification of digital offers is also fundamentally different from group purchasing methods and systems that aggregate buyers to lower the price. Group purchasing comes in various forms such as collective bargaining, purchasing clubs, and web based groupon/tipping point methods. Group purchasing methods are disclosed in U.S. Pat. No. 8,650,072 and U.S. Pat. No. 8,903,733. From an economic perspective the group purchasing methods fall in the category of pure monetary incentive offers but they also minimize the loss of margin by increasing the quantity of goods sold in a single order. Social gamification does neither guarantee a purchase nor requires a group purchasing order. Furthermore, social gamification nudges consumers to buy using soft incentives such as peer persuasion and does not aggregate individuals with explicit intent to buy.

The gamification method in the present invention is also fundamentally different from the gamification methods disclosed in the prior art. Gamification is generally defined as process where game like incentives and dynamics are used to achieve desired individual or group behaviors. The gamification methods disclosed in various patent applications, such as US20140379914 A1, US20150012393 A1, US20140195272 A1, US20150056578 A1, US20140274413 A1 apply game dynamics to encourage learning, better driving, productivity enhancements, goal achievement, optimize consumer check out at retailers, optimize customer service consumption, etc. The particular gamification method in these disclosers is user actions tracking for status achievement. Users are given different status badges based on the levels they have achieve through their actions. They receive rewards, services, or other benefits based on their badge status. Status based gamification is only one of the many gamification methods discussed in game theory and behavioral economics but it cannot be applied to the gamification of commercial offers. Status based gamification is applicable for single player games. The social gamification of offers falls within the branch in game theory of multiplayer games as the actions of each player participating in the gamified offers affects the actions of other participants as is disclosed in the detailed description of the present invention. The present method falls within the cooperative or mixed games where many participants act together to achieve a common goal, e.g., they vote on offers to unlock them and to increase the value of the offer. The social gamification of offers also falls within the branch of unlockable gaming where some game content is not accessible until the user performs a certain action. The present invention provides a method and a system to make gamification applicable to commercial offers.

### SUMMARY OF THE INVENTION

In accordance with the embodiments described herein, a method and a system is disclosed for creating and processing of digital socially gamified interactive offers. This summary is not an extensive overview, and it is not intended to identify key/critical elements or delineate the scope thereof. Its sole purpose is to present some concepts in a simplified form as a prelude to more detailed description that is presented late.

The method and system for creating and processing of socially gamified offers allows both businesses and consumers to create such offers. It provides means for business users, store assistants for example, to create socially gamified offers on computers, tablets and smart mobile phones by specifying an item picture, offer conditions, price and other attributes, and most importantly the type of social gamification and the required user votes for unlocking each offer. Next, the offer is posted to a particular individual or to groups of individuals via social networks, such as Facebook®, Twitter®, etc., via email, such as GMail®, Hotmail®, etc., or via text messaging such as SMS, WhatsApp®, etc. Next, consumers accept to participate in the gamified offer either by voting or by sharing it with other users to collect votes. Next, a vote counter for each offer is initiated to collect and count votes across all channels to which the offer was posted and shared. Each offer allows for additional interactions such as commenting for example. Next, an application server collects and stores in real time all votes, comments, and other interactions with the offer from all networks. Next, the method and system tabulates the votes and sends real-time updates and notifications to all participants. Next, if the voting requirements are met, the application server unlocks the offer, notifies the participants, and issues purchasing instructions. Finally, the application server manages the closing of the offer and the reporting of the offer engagement to the offer issuer.

The method and system further provides means to create and process a publicly unlockable competitively gamified interactive offer and post it to all members of a social network, an email group, or a sms group. Any person can vote on the offer and re-share it to solicit more votes from other people. Every person who votes on the offer accepts to participate in it, can view the voting results in real time, and receives notifications when the offer is unlocked. The item on offer has a limited supply, and, thus, after the offer is unlocked any of the participants can purchase the item on a first come, first served basis until supplies last.

The method and system further provides means to create and process a cooperative publicly unlockable offer where every user votes to unlock the offer and every user can purchase the item on offer until the offer expires.

The method and system further provides means to create and process an individual non-sharable offer. This offer can only be initiated for the particular recipient and can be shared only for vote collection.

The method and system further provides means to create and process an individual sharable gamified offer where each individual can initiate the offer and also re-post it to other individuals who can initiate it for themselves.

The method and system provides means for consumers to post a notification to retailers of their purchase intent, who in turn can append a gamified offer the consumer's post.

### BRIEF DESCRIPTION OF THE DRAWINGS

FIG. 1A shows a publically unlockable socially gamified offer on an internet connected consumer device;

FIG. 1B shows the accepted publically unlockable socially gamified offer on an internet connected consumer device;

FIG. 2A illustrates an unlocked socially gamified offer on an internet connected device;

FIG. 2B illustrates a closed socially gamified offer on an internet connected device;

FIG. 3 illustrates an individual non-sharable socially gamified offer;

FIG. 4 shows a re-posted for voting individual non-sharable socially gamified offer;

FIG. 5A shows an individually unlockable sharable socially gamified offer;

FIG. 5B illustrates the display of the incoming voting results and comments for the individually unlockable sharable socially gamified offer;

FIG. 5C shows the individually unlocked sharable gamified offer;

FIG. 6A illustrates a re-posted for voting offer as it is displayed on a friend's device;

FIG. 6B shows the votes tabulation on the friend's device after voting on the offer;

FIG. 7 is a high level diagram of a system and process flows for retailer initiated social gamification;

FIG. 8 is a high level diagram of a system and process flows for consumer initiated social gamification;

FIG. 9A illustrates the top part of a scrollable interface for creating socially gamified offers by business users on internet connected devices;

FIG. 9B illustrates the bottom part of the scrollable interface for creating socially gamified offers by business users;

FIG. 10 illustrates the consumer interface for initiation of social gamification;

FIG. 11 illustrates the display of the consumer initiated socially gamified post on other consumers' devices.

### DETAILED DESCRIPTION OF THE INVENTION

Various embodiments of the present invention will be described in detail with the reference to the drawings, where like reference numerals represent like parts and assemblies throughout the several views. References to various embodiments do not limit the scope of the invention, which is limited only by the scope of the claims attached hereto. Additionally, any examples set forth in this specification are not intended to be limiting and merely set forth some of the many possible embodiments for the claimed invention. Among other things, the present invention may be embodied as methods or devices. Accordingly, the present invention may take the form of an entirely hardware embodiment, and entirely software embodiment, or an embodiment combining software and hardware aspects. The following detailed description is, therefore, not to be taken in a limiting sense.

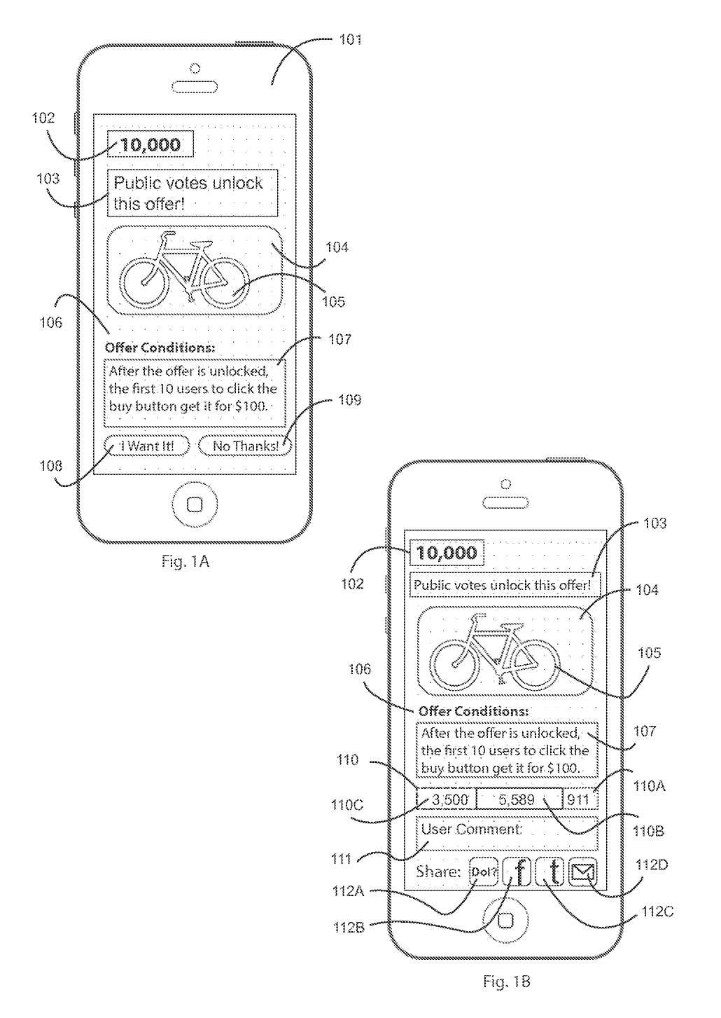

FIG. 1A is an illustration of the display of a publically unlockable socially gamified offer on a consumer mobile device 101. For those skillful in the art it will be obvious that such offers can be displayed on any internet connected device. A parameter 102 displays the required votes to unlock the offer as set by the offer issuer. A parameter 103 displays the type of unlocking required for this particular offer as set by the offer issuer. In this particular illustration the parameter 103 displays a message indicating that the offer can be unlocked by the general public, e.g., any person who has received or has came across the offer on a social network, via email, or via text massage can vote to unlock the offer and take advantage of it subject to the offer conditions and limitations. An image container 104 displays a picture 105 of the item on offer. Label 106 describes the text box 107 which displays the conditions of the offer as set by the offer issuer. Buttons 108 and 109 allow users to accept or decline to participate in the socially gamified offer. A click or a tap on button 108 is processed by the system as a “Yes” vote and when the offer is unlocked the consumer receives a purchase authorization as shown later on in this specification. A click or a tap on button 109 is processed by the system as a “No” vote and the user does not get any notification when the socially gamified offer is unlocked. Those skillful in the art will immediately understand that alternative layout designs are possible, as well as that additional parameters can be appended to the socially gamified offer.

FIG. 1B illustrates the new state of the socially gamified offer application after the consumer has clicked on either button 108 or button 109 in FIG. 1A. The gamified offer application displays the offer attributes from the prior display on FIG. 1A—parameter 102 displaying the required votes to unlock the offer, parameter 103 displaying the type of unlocking required, the image container 104 and the item picture 105, and the label 106 for the text box 107 displaying the offer conditions. In addition, the new state displays a bar chart component 110 showing the vote counts in three sections. Section 110A shows the “No” votes, section 110B shows the “Yes” votes and section 110C shows the remaining votes to unlock the socially gamified offer. A text input control 111 allows consumers to post comments about the offer. Finally, consumers can spread the word and solicit more votes by sharing the socially gamified offer via social networks such as 112A “Do I Get It?” network, 112B Facebook, 112C Twitter, or email 112D. Those skillful in the art will immediately understand that sharing can be done via any social network, email network, sms or other texting application.

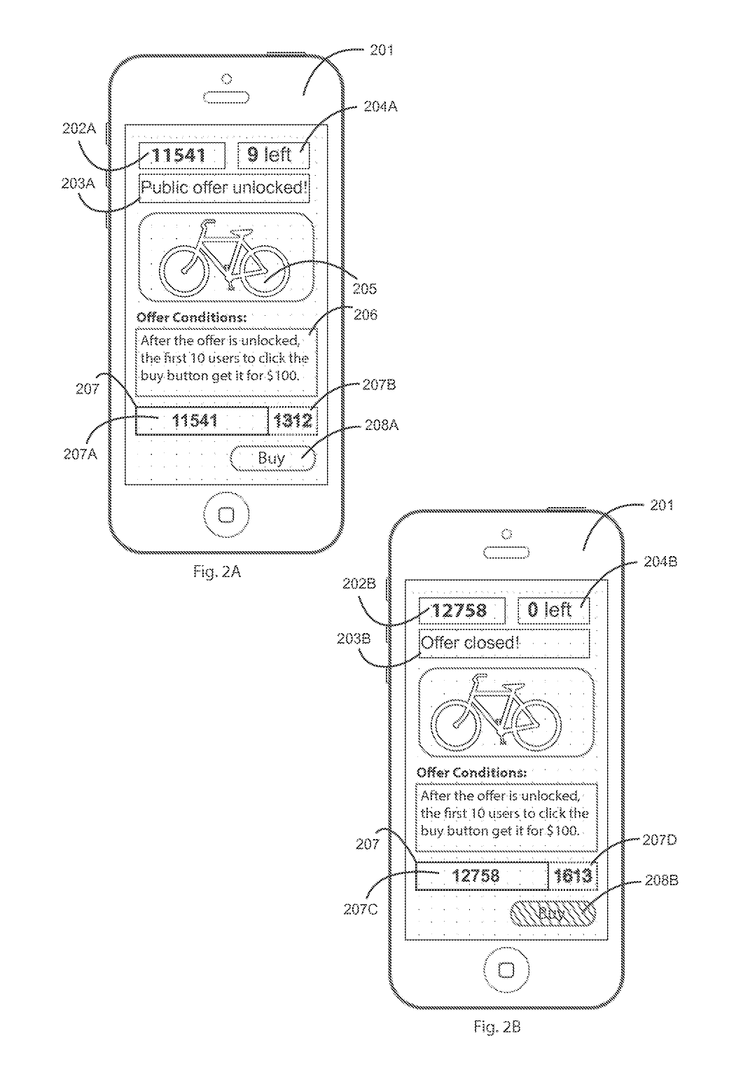

FIG. 2A illustrates the unlocked socially gamified offer on a consumer mobile device 201. Parameter 202A shows the total number of votes collected for unlocking the offer. The total votes can exceed the number of votes required for unlocking the offer because users can continue to vote after the offer is unlocked in order to obtain a purchase authorization. Voting after unlocking can continue until supplies last, until the offer expires, or until some other condition specified by the offer issuer occurs. Parameter 203A automatically displays a message that the offer is unlocked. Parameter 204A indicates the remaining items in stock for a limited quantity offer. The limited quantity socially gamified offers are competitive in nature as consumers take advantage of the offer on a ‘first come, first served’ basis while supplies last. 205 is a picture of the item on offer and 206 is a text box with the conditions of the offer. 207 is a bar chart component showing the positive and negative votes in sections 207A and 207B respectively. 208 is a buy button that allows the consumer to connect to a web site and purchase the item at the offer price. Those skillful in the art will immediately understand that purchase authorization and purchasing can be implemented in a variety of ways.

FIG. 2B shows the change of the state of the socially gamified offer application when the supplies have finished and the offer has closed. Parameter 204B shows that there are no available items. Parameter 203B automatically displays a message that the offer is closed. The count in parameter 202B has increased compared to the count in parameter 202A on FIG. 1A to illustrate that the voting has continued until the offer was closed. The counts in sections 207C and 207D of the bar chart component 207 have also changed compared to the counts on FIG. 1A to illustrate that the voting has continued until the offer was closed. The buy button 208B is automatically grayed-out when the supplies are finished in order to disable the access to the purchasing web page for the offer. However, the offer issuer can specify another button or method to redirect consumers to a web page where the item is available at a regular price.

FIG. 3 illustrates a non-sharable socially gamified offer issued to a particular individual and displayed on her mobile device 301. Only the consumer to whom the offer is issued can take advantage of the non-sharable socially gamified offer. The consumer can post her offer to her friends to collect the required votes to unlock the offer for herself. Parameter 302 displays the number of friends' votes required by the issuer to unlock the offer. Parameter 303 displays an auto-generated message with the requirements to unlock the offer, e.g., collect 50 votes from friends using social media, email, or sms. 304 is a picture of the item on offer and text box 305 shows the conditions of the offer. Buttons 306 and 307 allow the individual to decline or to accept to participate in the gamified offer. If the consumers clicks button 307, the issuer is notified that the consumer has declined to participate in the offer. If the consumer clicks button 306, the offer is initiated for vote tracking and the consumer can re-post it via social networks, email, and SMS to collect votes. When the offer is unlocked the consumer is presented either a buy button or a purchase authorization code as shown on other drawings in this specification.

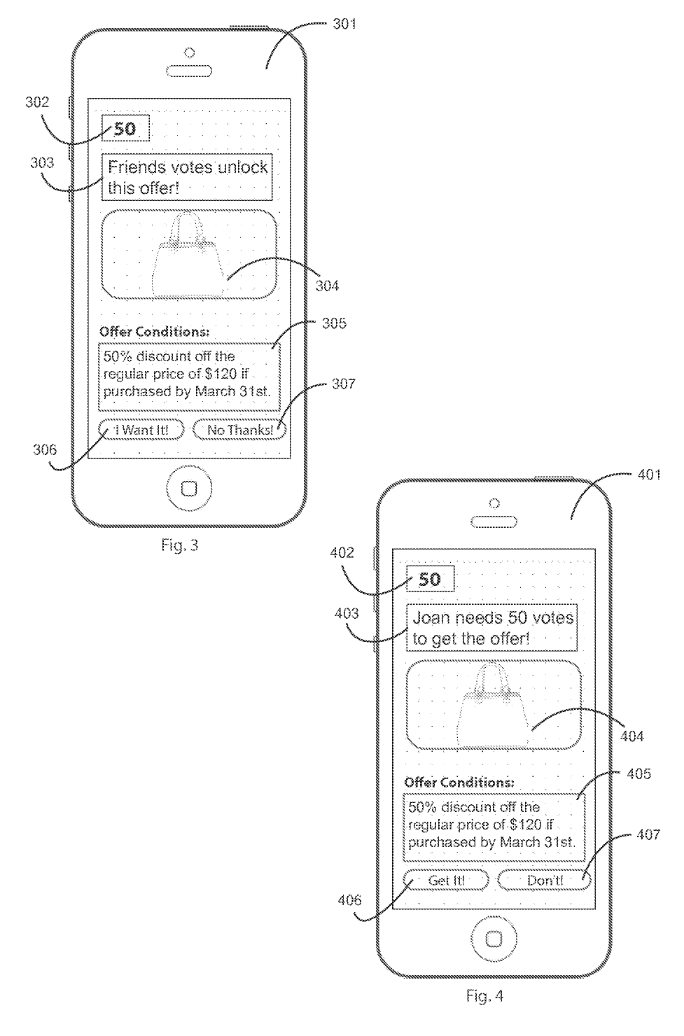

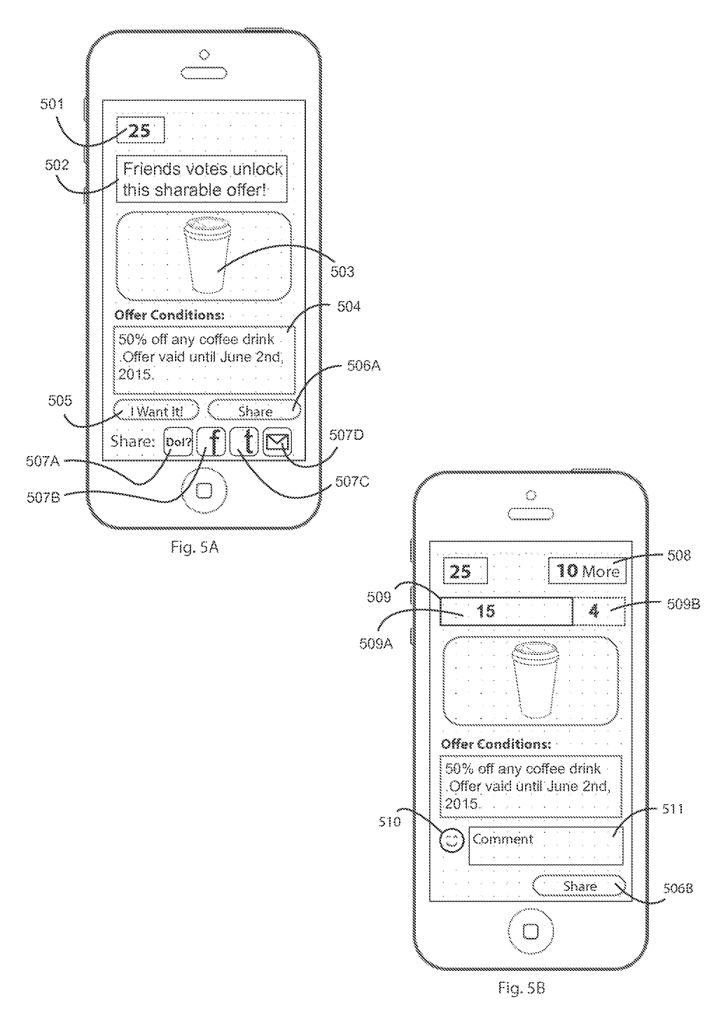

FIG. 4 shows the re-posted for voting non-sharable socially gamified offer from FIG. 3 as it is displayed on a friend's mobile device 401. Parameter 402 shoes the votes that are required to unlock the offer. Parameter 403 shows an auto-generated post message that the individual is collecting votes to unlock an offer. 404 is a picture of the item on offer and text box 405 shows the conditions of the offer. Voting buttons 406 and 407 allow the offer recipient's friends to cast their votes. The offer issuer can specify whether the offer allows voting only or also commenting and other interactions.

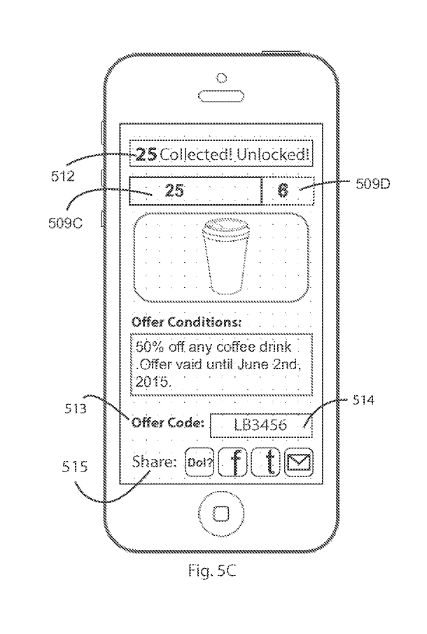

FIG. 5A shows an individually unlockable sharable socially gamified interactive offer. This offer can be shared with anyone, but everyone who chooses to participate has to collect votes from his friends to unlock the offer for himself. Parameter 501 displays the required friends' votes to unlock the offer. Parameter 502 displays the conditions to unlock the offer. 503 is a picture of the item on offer. Text box 504 shows the offer conditions, e.g., expiration, discount rate, etc. 505 is button to accept to participate in the offer. Clicking or tapping on button 505 activates the offer in the system and initiates a separate vote counter just for this individual to collect votes from his friends. Button 506A allows the individual to share the offer with his friends who can activate it for themselves. The offer is shared via the posting methods for social networks 507A, 507B, 507C, and for email system 507C.

FIG. 5B show how the individual can monitor the voting process within the application. Parameter 508 displays the remaining votes required for the unlocking of the offer. Bar chart component 509 displays the counts of the “Yes” and “No” votes in sections 509A and 509B respectively. Text box 511 displays friends' comments on the offer. 510 is the avatar of the person posting the comment. Button 506B enables the sharing of the offer both for collecting votes to unlock it and for other users to initiate it for themselves. Button 506B has been repositioned compared to FIG. 5A because the application screen layout changes dynamically based on the status and stage of the application.

FIG. 5C shows the individually unlocked offer. Parameter 512 displays an auto-generated message that the required votes have been collected and that the offer is unlocked. The counts in sections 509C and 509D of the bar chart component 509 from FIG. 5B are updated to reflect the real-time vote counts. Label 513 shows the dynamically generated purchase authorization code 514 which can be presented at stores or entered on web sites to get the offer price or the discount. Label 515 indicates that sharing is still allowed so that the offer can be distributed to other users who may be interested in it. Sharing is enabled until the offer expires or until another condition set by the offer issuer occurs.

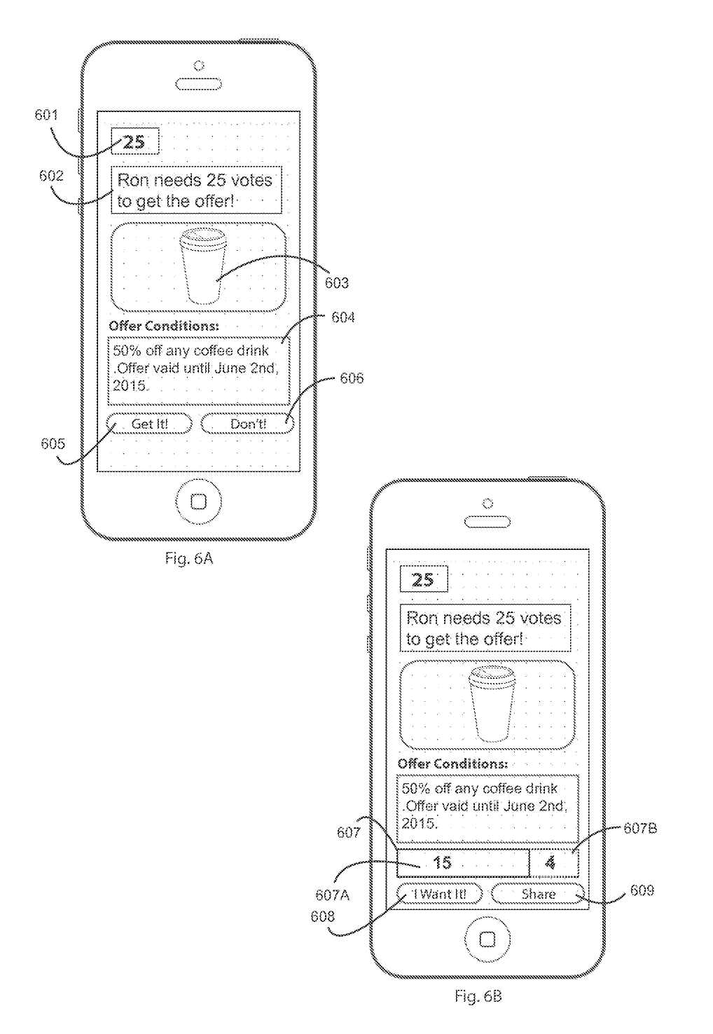

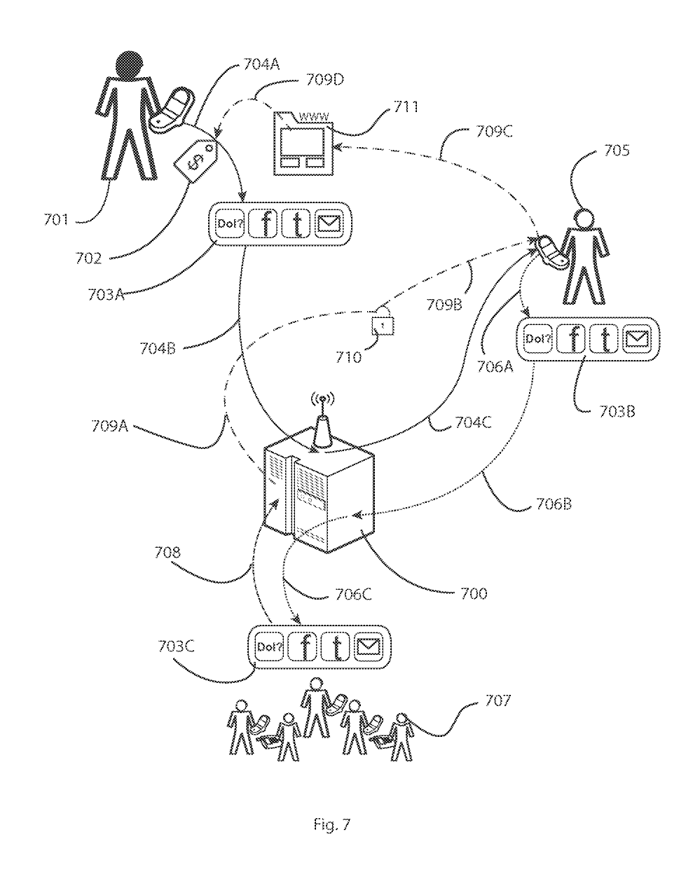

FIG. 6A shows the re-posted for voting offer as it appears on a friend's device. Parameter 601 displays the required votes. Parameter 602 is an auto-generated post indicating the reasons for making the post. 603 is a picture of the item on offer. Text box 604 shows the conditions of the offer. Voting buttons 605 and 606 allow the friends with whom the post is shared to cast their votes which are collected and tabulated by the system in real time.

FIG. 6B shows the change in the application status after a vote is cast. The voting buttons 605 and 606 from FIG. 6A have been removed to display the tabulated voting results and sharing options. A bar chart component 607 displays the “Yes” and “No” votes in sections 607A and 607B respectively. Button 608 enables the user to initiate the offer for herself. Button 609 allows the user to share the offer with other individuals without initiating it for herself.

FIG. 7 is a high level diagram showing the issuing of a socially gamified offer by a retailer or other business user, and its operationalization and processing by the system. There are four digital process flows in the system. The first process flow is defined by path segments 704A, 704B and 704C showing the creation, distribution, and access of the offer. Store associate 701 creates a socially gamified offer 702 on an internet connected device, selects a posting method 703A in the application posting interface which posts the offer 702 to an application server 700 and to the specified social networks and communication channels. The post is received directly or becomes viable within a social network post feed by a consumer 705. The second process flow is defined by path segments 706A, 706B, and 706C showing the sharing of the post with other individuals either for vote collection or as an offer recommendation. Consumer 705 selects a posting method 703B in the application posting interface which posts the offer 702 to the application server 700 and to the specified social networks and communication channels where it becomes accessible to individuals 707. The third process flow is defined by path 708. The individuals 707 can post votes or re-share the offers via the posting method 703A in the application posting interface. The votes and the re-sharing are processed by the application server 700 in real time. The forth process flow is defined by path segments 709A, 709B, 709C, and 709D which show the tabulation of votes, offer unlocking, offer fulfilment, and offer closing by the application server 700. The application server 700 tabulates the votes of individuals 707, determines when the conditions of the offer are met, and issues unlock key 710 to consumer 705 with purchase instructions or a link to a web page 711. The application server 700 tracks offer closing conditions, such as quantities sold, expiration date, etc., closes the offer and notifies the offer issuer as indicated by path segment 709D.

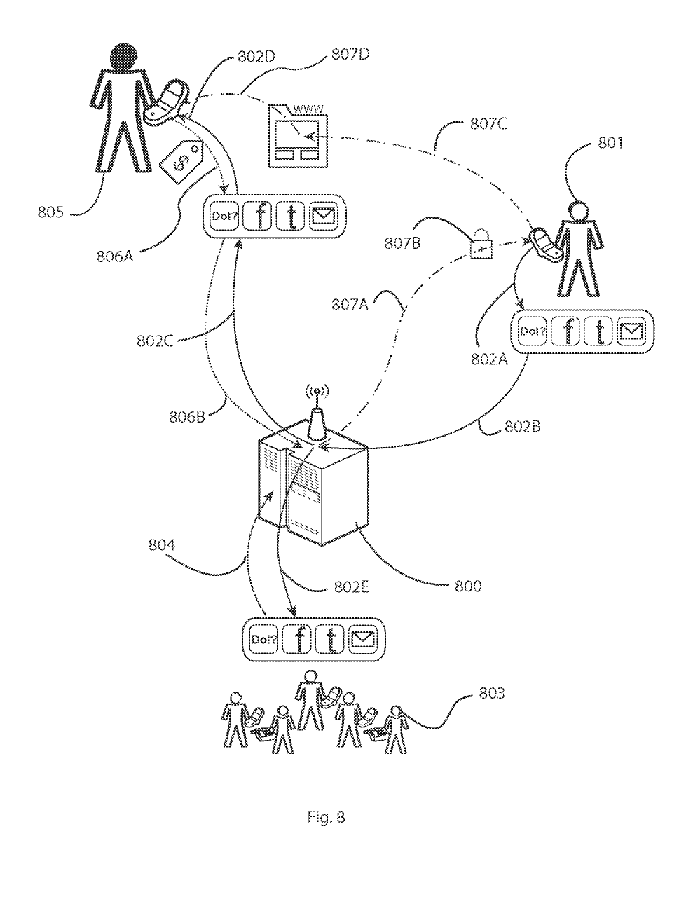

FIG. 8 illustrates how the system processes a consumer initiated gamification. Consumer 801 creates a post in which he specifies under what conditions he is willing to buy an item and posts it to the system. The system delivers the post via process flow defined by segments 802A, 802B, 802C, 802D, and 802D to both the consumer's friends 803 and to a store assistant 805 from where the consumer wants to purchase the item. The consumer can notify multiple stores of his purchase intent. Process flow 804 collects votes and comments from the friends of the consumer and tabulates them on the application server 800. Process flow defined by segments 806A and 806B shows how the store assistant 805 can append gamification rules to the consumer's post 801. Process flow defined by segments 807A, 807B, 807C and 807D shows the processing of the offer conditions, the issuing of the unlock key and the purchasing authorization, and the offer fulfilment and closing.

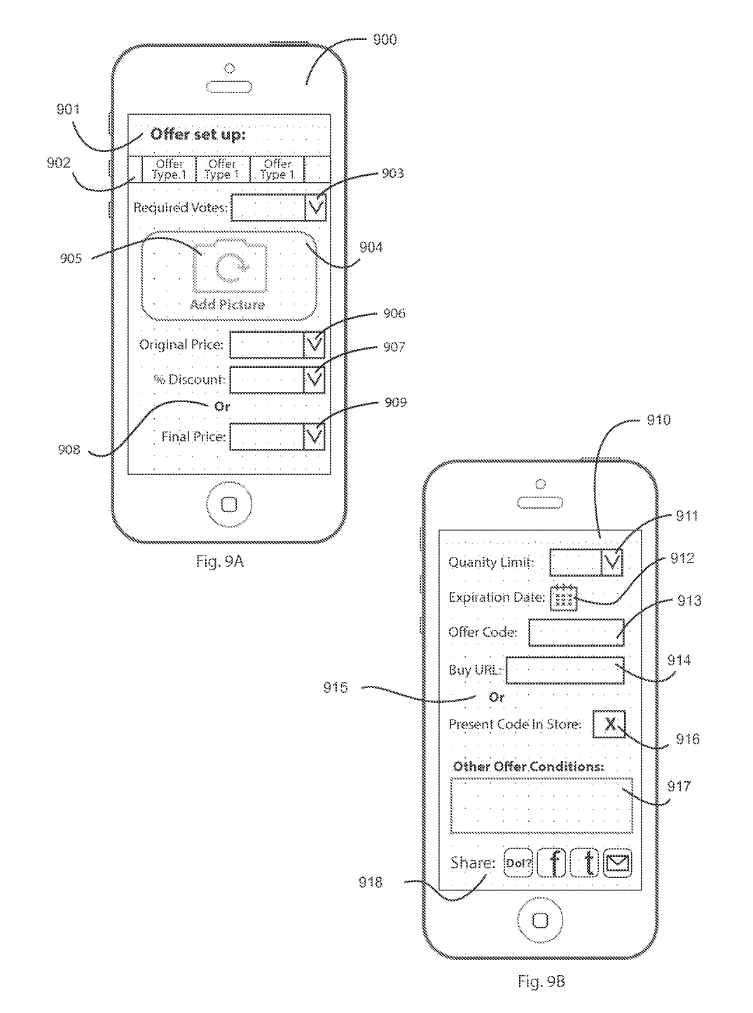

FIG. 9A illustrates the creation of a socially gamified offer by a business user on a mobile device 900. 901 is a screen label for the offer creation module of the application. 902 is tap bar component for selecting the offer type that the user wants to create. For desktops, laptops and other internet connected devices the tap bar is replaced with a toolbar component or another native component for user selections. 903 is an input component for the business user to select or type in the required votes for unlocking the offer. 904 is an image insertion component. 905 is an icon to indicate to the business user the required action to insert an image. 906 is an input control for the original price of the item. 907 is an input control for the discount rate. 909 is an input control for the final price. Label 908 indicates that input controls 907 and 909 are mutually exclusive, e.g., the business user can enter either a discount rate or an exact price amount.

FIG. 9B shows the scrolled down portion 910 of the application interface shown on FIG. 9A. 911 is an optional input control to specify quantity limits. 912 is a calendar input control to specify the expiration date of the offer. 913 is an input control to enter a purchase authorization code for this particular offer. Purchase authorization codes can be generated manually or programmatically. 914 is an input control for the offer URL used to automatically generate the buy button described earlier in this specification. 916 is an input control to specify that the offer is redeemable only in stores. When 916 is selected the automatic generation of the buy button is disabled. Label 915 indicates that the URL and the purchase authorization code can be made mutually exclusive if the offer issuer wants to make purchasing available through only one channel. 917 is a text input control for defining the offer conditions. 918 is a label indicating the available posting options for social and communications networks. Those skillful in the art will immediately understand that alternative layout designs are possible and additional parameters can be appended to the offer, as well as that many of the parameters can be automatically retrieved and populated in the application from existing CRM systems.

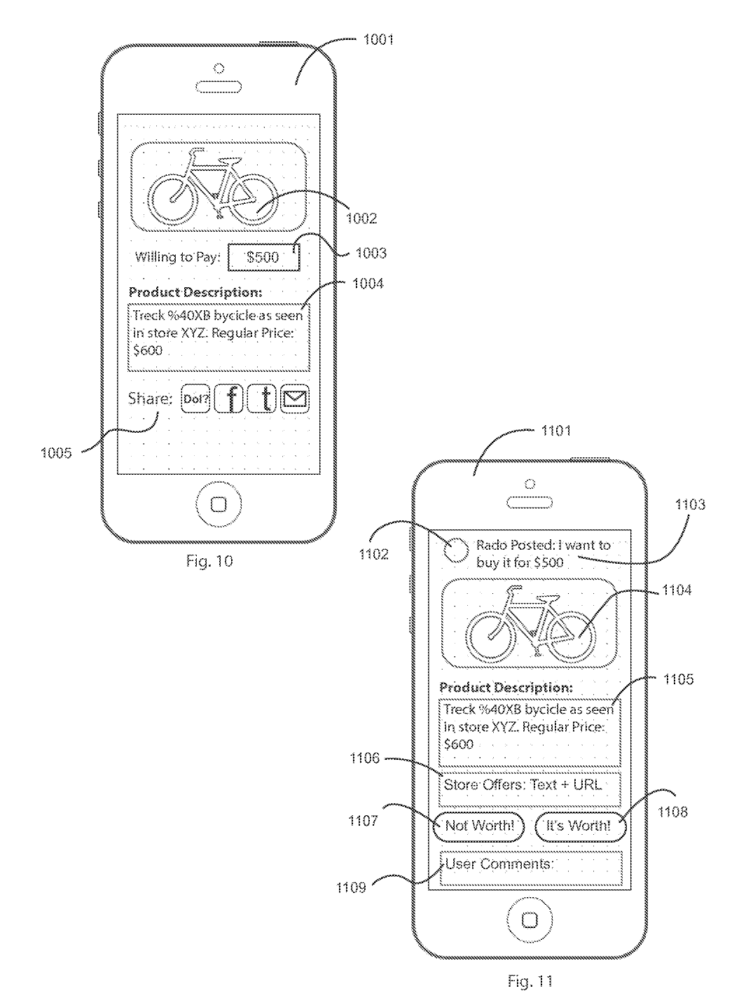

FIG. 10 shows a consumer-to-business gamification post creation on a consumer mobile device 1001. 1002 is a picture of the desired item by the consumer. 1003 is an input control for the consumer to enter the price that she is willing to pay for the item shown in 1002. 1004 is an input text box for the consumer to describe the item shown in 1002. 1005 is a label that indicates the posting options for social and communications networks which the consumer can use to notify the retailer directly of her willingness to purchase. The system can also generate automatic notifications from the consumers' posts to retailers and other businesses based on hash tags and other standard web methods.

FIG. 11 shows the consumer-to-business gamification post as seen by the friends of the consumer on their mobile devices 1101. 1102 is the avatar of the consumer making the post. 1103 is the automatically generated post message. 1104 is an image of the desired item. 1105 is the desired item description as posted by the consumer. 1106 is a text container for retailers to append offers and purchasing conditions relevant to the consumer's post. 1107 and 1108 are buttons for the friends of the consumer to vote on the desired item and on the appended offers. 1109 is a text input box for the consumers' friends to provide comments.

What is claimed is:

1. A method for social gamification of offers, comprising:
preparing a digital offer post by providing a visual or a textual description, an incentive and a purchasing instruction;
specifying a social gamification rule for user interactions with the digital offer post;
locking the digital offer post by specifying a computable threshold condition for the user interactions with the digital offer post;
posting the digital offer post to electronic networks and communication systems;
displaying the digital offer post on personal internet connected devices for users to access the digital offer post;
collecting and storing the user interactions with the digital offer post;
sharing the digital offer post by users to engage other users with the digital offer post;
initiating a counter to compute statistics on the user interactions;
disseminating the computed statistics to the users interacting with the digital offer post;
comparing the computed statistics against the computable threshold condition;
unlocking the digital offer post when the computable threshold condition is satisfied;
presenting the purchasing instruction; and
closing the digital offer post.

2. The method in claim 1 wherein the user interactions with the digital offer post comprise voting.

3. The method in claim 1 wherein the user interactions with the digital offer post comprise commenting.

4. The method from claim 1 wherein the social gamification rule specifies a public collection of user interactions in a single instance of the counter.

5. The method from claim 4 further comprising:
specifying a limited quantity competitive first come first serve purchasing instruction.

6. The method from claim 4 further comprising:
specifying a non-competitive unlimited quantity limited time purchasing instruction.

7. The method from claim 1 wherein the social gamification rule specifies an individual collection of user interactions in multiple instances of the counter.

8. The method from claim 1 wherein the digital offer post is restricted to a single individual by initiating a single instance of the counter.

9. The method of claim 1 further comprising:
preparing a consumer initiated partial digital offer post by providing a visual or a textual description and a desired incentive;
posting the consumer initiated partial digital offer post to an electronic network or communication system;
informing a business about the consumer initiated partial digital offer post;
allowing the business to complete digital offer post by appending a gamification rule, a computable locking condition and a final incentive to the consumer initiated partial digital offer post; and
re-posting the digital offer post to the consumer.

10. A computer based system for social gamification of offers, comprising:
a first user interface located or accessible on an internet connected device, the user interface being configured to create a digital offer post including a visual or a textual description, a consumer incentive, a gamification rule for user interactions with the digital offer post, a computable threshold condition for locking the digital offer post, a purchasing instruction and a web application programming interface for posting the digital offer post to a network application server, user selected electronic networks and communication systems;
a second user interface located or accessible on an internet connected device, the second user interface being configured to display the digital offer post created with the first user interface including interactive user controls and a web application programming interface to transmit user interactions to the network applications server or to share the digital offer post with other users via the user selected electronic networks and communication systems;
the network application server further configured to receive the digital offer post from the first user interface and to initiate a counter for computing statistics on the user interactions with the digital offer post;
the network application server further configured to receive user interactions from the second user interface, to compute statistics on the user interactions, to evaluate the computable threshold condition, to unlock the digital offer post that satisfies the computable threshold condition, to generate the purchasing instruction to be displayed on the second user interface and to close the digital offer post;
a database, said database being configured to store the digital offer posts and the user interactions with digital offer posts;
the network application server further configured to query and retrieve data from the database;
the network application server further configured to push data and statistics retrieved by the query to be displayed on the first user interface and on the second user interface; and
the network application server further configured to push notifications to the users about the status of the digital offer post to be displayed on the first user interface and on the second user interface.

11. The system of claim 10 wherein the system is further configured to:
lock the digital offer post based on a computable user interactions condition including a parameter to set a threshold, an algorithm to compute the user interactions and a logical operator to evaluate the condition and unlock the digital offer post if the computed user interactions satisfy the threshold.

12. The system of claim 10 wherein the system is further configured to:
Push real-time gamification statistics to users.

13. The system of claim 10 wherein the gamification rule is further configured for a public collection of user interactions in a single counter.

14. The system of claim 10 wherein the gamification rule is further configured for an individual collection of user interactions in separate counters for each user.

15. The system of claim 10 wherein the gamification rule is further configured for an individual collection in one counter for one user.

16. A computer program product embodied in non-transitory computer-readable media carrying executable code, which code when executed:
produces a digital offer post having a visual or a textual description, an incentive, a gamification rule for user interactions and a lock condition based on computable user interactions;
distributes the locked digital offer post to user selected electronic networks and communication systems;
stores tracking data on the ways in which different users interact with the digital offer post over time;
computes user interaction statistics from the said tracking data to evaluate the lock condition;
pushes the user interactions statistics to users in real time;
unlocks the digital offer post when the lock condition is satisfied;
generates purchasing instructions, and
closes the digital offer post.

17. The computer program product of claim 17, wherein the code when executed generates a publically unlockable digital offer post for a limited quantity item.

18. The computer program product of claim 17, wherein the code when executed generates a publically unlockable offer digital offer post with a fixed expiration date for an unlimited quantity item.

19. The computer program product of claim 17, wherein the code when executed generates a personal non-sharable individually unlockable digital offer post.

20. The computer program product of claim 17, wherein the code when executed generates multiple individually unlockable instances of the digital offer post.
